(19) United States
(12) Patent Application Publication
(10) Pub. No.: US 2007/0199508 A1
(43) Pub. Date: Aug. 30, 2007

(54) Substrate holder and substrate treatment apparatus

(75) Inventor: Takiyoshi Sakai, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/453,478

(22) Filed: Jun. 14, 2006

(30) Foreign Application Priority Data
Jun. 24, 2005 (JP) 2005-184617
Mar. 28, 2006 (JP) 2006-086818

(51) Int. Cl. B08B 3/04; B08B 3/00; B05C 3/00

(52) U.S. Cl. 118/423; 134/135; 134/104.2; 118/500; 118/429; 118/503

(57) ABSTRACT

A substrate holder whose component members are not being corroded even if employing a high concentration of hydrofluoric acid, phosphoric acid, or sulfuric acid as a treatment solution when plural pieces of substrates are held with a substrate holder and immerses in the treatment solution in a treatment reservoir for treatment. The substrate holder 12 comprises a moving member 26 that is made of SiC and is supported to be movable between inside and outside of a treatment reservoir 10 where a treatment solution is stored; a plurality of substrate retainer frames 28 and 30 that are fixed to the moving member 26, and located in a horizontal direction along the array direction of substrates W; and retainer members 34a, 34b, 36a, 36b that are formed at the substrate retainer frames 28 and 30, and are held being in contact with the lower end portions of the substrates W.

### BACKGROUND OF THE INVENTION

1. Field of the Invention

The present invention relates to a substrate holder, being one of components of a substrate treatment apparatus for immersing plural pieces of substrates in a treatment solution that is stored in a treatment reservoir to carry out the treatment, and causing plural pieces of substrates to be arrayed in a standing posture to hold, as well as to a substrate treatment apparatus provided with this substrate holder.

2. Description of the Related Art

Generally, in a substrate treatment apparatus acting to immerse substrates in a treatment solution stored in a treatment reservoir to make, e.g., cleaning and etching, plural pieces of substrates are held using a substrate holder, and this substrate holder is made to move between inside and outside of the treatment reservoir to insert the substrate holder in the treatment reservoir, thereby immersing the substrates in the treatment solution in the treatment reservoir to make the treatment. Further, the substrate holder possesses the construction enabling plural pieces of substrates to be arrayed in a standing posture without being in contact with each other to hold. For example, a substrate holder comprises a lifter member (moving member) that is supported so as to be capable of moving between inside and outside of a treatment reservoir that is disposed in the vertical direction; a plurality of substrate retainer frames in each of which one end is fixed to the lower end portion of the lifter member, and which are disposed in the horizontal direction, for example, a central substrate retainer frame fixed to the central portion of the lower end portion of the lifter member, and substrate retainer frames on the left and right fixed to both sides of the lower end portion of the lifter member respectively; a fixed frame (fixed member) that is fixed to the other ends of these substrate retainer frames respectively, and that is disposed in the vertical direction; and retainer members that are secured to each of the substrate retainer frames respectively, that include a plurality of substrate retainer grooves to engage with the lower edges of substrates, and that cause plural pieces of substrates to be arrayed in the horizontal direction in a standing posture respectively at a little spacing from each other to hold.

The substrate holder of such construction is immersed in a treatment solution in the treatment reservoir to be in contact with the treatment solution. Therefore, as disclosed, for example, in the Japanese Patent Publication (unexamined) No. 49073/1996, a lifter member or a fixed frame, being one of component members thereof, is made of quartz glass, and the surface of this quartz glass base material is coated with fluororesin having high corrosion resistant properties.

Although the lifter member or the fixed frame of a substrate holder is made of quartz glass and the base material surface thereof is coated with, e.g., fluororesin, in the case of employing a high concentration of not less than 5% of hydrofluoric acid (HF), phosphoric acid (H₃PO₄), or sulfuric acid (H₂SO₄) as a treatment solution, a problem exists in that a treatment solution gets inside the fluororesin film, the fluororesin film comes off from the quartz glass base material, and a lifter member and a fixed frame come to be corroded.

### SUMMARY OF THE INVENTION

The present invention was made in view of the above-described state of arts, and has an object of providing a substrate holder of which component members are in no fear of being corroded even in the case of employing a high concentration of hydrofluoric acid, phosphoric acid, or sulfuric acid as a treatment solution when plural pieces of substrates are held with a substrate holder, and are immersed in the treatment solution in a treatment reservoir to carry out the treatment, and a substrate treatment apparatus provided with such a substrate holder.

The invention as set forth in claim 1 is a substrate holder, which causes plural pieces of substrates to be arrayed in a standing posture to hold, comprising: a moving member that is capable of moving between an internal part of a treatment reservoir in which a treatment solution is stored, and positions above the mentioned treatment reservoir, and that is made of SiC (silicon carbide); a plurality of substrate retainer frames that are fixed to the mentioned moving member, and are located in a horizontal direction along the array direction of the substrates respectively; and a retainer member that is formed at the mentioned substrate retainer frames, and is in contact with the lower end portions of the substrates to hold the substrates.

The invention as set forth in claim 2 is the substrate holder according to claim 1, in which a CVD (chemical vapor deposition) SiC film is deposited on the surface of the mentioned moving member.

The invention as set forth in claim 3 is the substrate holder according to claim 2, in which the mentioned CVD SiC film that is deposited on the surface of mentioned moving member is 10 μm to 30 μm in thickness.

The invention as set forth in claim 4 is the substrate holder according to any one of claims 1 to 3, in which the mentioned substrate retainer frame is made of SiC.

The invention as set forth in claim 5 is the substrate holder according to claim 4, in which a CVD SiC film is deposited on the surface of the mentioned substrate retainer frame.

The invention as set forth in claim 6 is the substrate holder according to claim 5, in which the mentioned CVD SiC film that is deposited on the surface of mentioned substrate retainer frame is 10 μm to 30 μm in thickness.

The invention as set forth in claim 7 is the substrate holder according to any one of claims 1 to 3, in which the mentioned retainer member is made of fluororesin.

The invention as set forth in claim 8 is the substrate holder according to claim 7, in which fluororesin to form the mentioned retainer member is any resin selected from the group consisting of polytetrafluoroethylene (PTFE), perfluoro alkoxyalkane (PFA), polyvinylidene fluoride (PVDF), polychloro-trifluoroethylene (PCTFE), and polyether ether ketone (PEEK).

The invention as set forth in claim 9 is the substrate holder according to any one of claims 1 to 3, in which the mentioned substrate retainer frame and the mentioned retainer member are secured together with a fastening device made of fluororesin.

The invention as set forth in claim 10 is the substrate holder according to claim 9, in which fluororesin to form the mentioned fastening device is any resin selected from the group consisting of PTFE, PFA, PVDF, PCTFE, and PEEK.

Each of the inventions according to claims 11 to 20 is a substrate treatment apparatus that comprises: a treatment reservoir in which a treatment solution is stored, and a substrate holder, which causes plural pieces of substrates to be arrayed in a standing posture to hold; and that contains plural pieces of substrates held with the mentioned substrate holder in an internal part of the mentioned treatment reservoir, and immerses the plural pieces of substrates in a treatment solution in the mentioned treatment reservoir to carry out the treatment. Further, each of the inventions as set forth in claims 11 to 20 comprises the substrate holder of each invention according to claims 1 to 10.

When using the substrate holder of each invention as set forth in claims 1 to 3, since the moving member is made of SiC, the moving member is in no fear of being corroded even in the case of employing a high concentration of hydrofluoric acid, phosphoric acid, or sulfuric acid as a treatment solution.

In the substrate holder of each invention as set forth in claims 4 to 6, since the substrate retainer frame is made of SiC, the substrate retainer frame is in no fear of being corroded even in the case of employing a high concentration of hydrofluoric acid, phosphoric acid, or sulfuric acid as a treatment solution.

In the substrate holder of each invention as set forth in claims 7 and 8, since retainer member is made of fluororesin having high chemical resistance, the retainer member is in no fear of being corroded even in the case of employing a high concentration of hydrofluoric acid, phosphoric acid, or sulfuric acid as a treatment solution.

In the substrate holder of each invention as set forth in claims 9 and 10, since fastening device to secure a retainer member to a substrate retainer frame is made of fluororesin having high chemical resistance, the fastening device is in no fear of being corroded even in the case of employing a high concentration of hydrofluoric acid, phosphoric acid, or sulfuric acid as a treatment solution.

In the substrate treatment apparatus of each invention as set forth in claims 11 to 20, since the moving member of a substrate holder is in no fear of being corroded even in the case of employing a high concentration of hydrofluoric acid, phosphoric acid, or sulfuric acid as a treatment solution.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross sectional view showing one example of preferred embodiments according to the present invention, and in which one example of essential construction of a substrate treatment apparatus is shown.

FIG. 2 is an enlarged cross sectional view of a main portion of a substrate holder taken from a front side, which is a component of the substrate treatment apparatus shown in FIG. 1.

FIG. 3 is a side view showing the main portion of the substrate holder shown in FIG. 1, which is in a partially broken state.

FIG. 4A is a partially enlarged cross sectional view showing a cross sectional structure of a lifter member of the substrate holder shown in FIGS. 2 and 3.

FIG. 4B is a partially enlarged cross sectional view showing the cross sectional structure of a lifter member of the substrate holder in the same manner.

### DESCRIPTION OF THE PREFERRED EMBODIMENTS

Hereinafter, a preferred embodiment according to the present invention is described referring to the drawings.

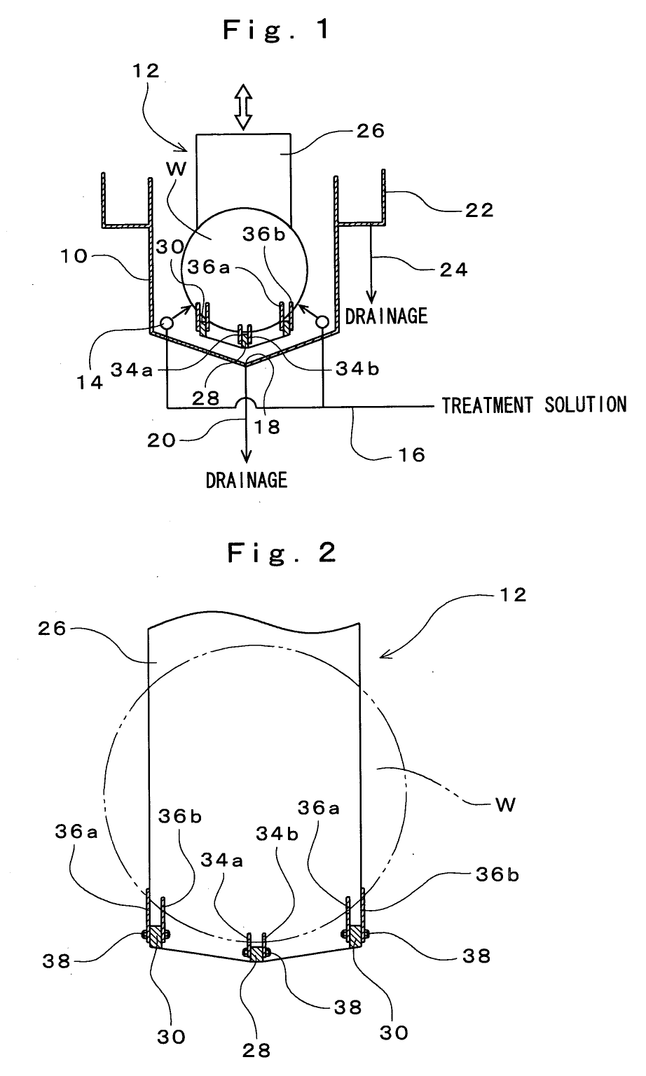

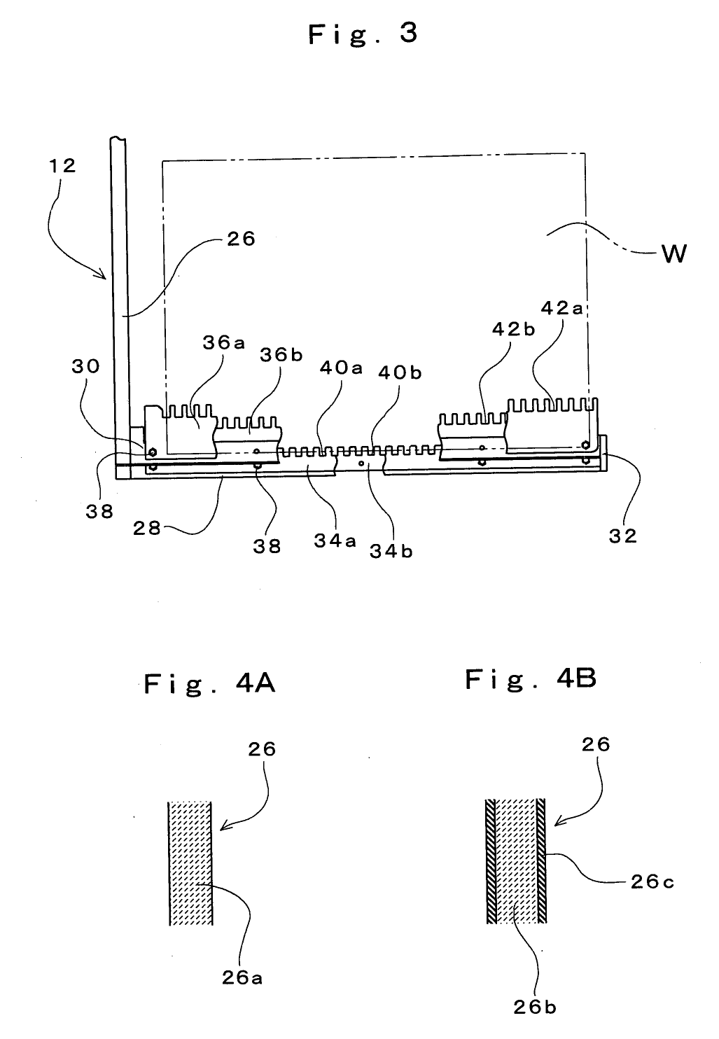

FIG. 1 to FIGS. 4A and 4B show respectively one of preferred embodiments according to the invention. FIG. 1 is a schematic cross sectional view showing one example of preferred embodiments according to the present invention, in which one example of essential construction of a substrate treatment apparatus is shown. FIG. 2 is an enlarged cross sectional view of a main portion of a substrate holder taken from a front side, which is a component of the substrate treatment apparatus shown in FIG. 1. FIG. 3 is a side view showing the main portion of the substrate holder shown in FIG. 1, which is in a partially broken state. FIGS. 4A and 4B are partially enlarged cross sectional views each showing a cross sectional structure of a lifter member of the substrate holder.

This substrate treatment apparatus is provided with a treatment reservoir 10 that stores a treatment solution, and a substrate holder (lifter) 12 that causes plural pieces of substrates W to be arrayed in a standing posture to hold. The substrate holder 12 inserts substrates W into an internal part of the treatment reservoir 10 to immerse the substrates W in a treatment solution in the treatment reservoir 10, as well as lifts up the substrates W from the treatment solution in the treatment reservoir 10 to take out the substrates W to positions above the treatment reservoir 10. Treatment solution feed openings 14 are formed at the lower portion of the treatment reservoir 10. A treatment solution feed pipe 16, which is a channel connected to the supply source of a treatment solution, for example, treatment solution of hydrofluoric acid, phosphoric acid or sulfuric acid, communicates with to the treatment solution feed openings 14 to be connected thereto. Furthermore, a drain 18 is formed at the bottom of the treatment reservoir 10, and a drainpipe 20 communicates with the drain 18 to be connected thereto. A solution pan 22 in which the treatment solution having overflowed out of the top of the treatment reservoir 10 flows is located at the upper peripheral portion of the treatment reservoir 10. A drainpipe 24 communicates with a drain that is formed in the bottom of the solution pan 22 to be connected.

The substrate holder 12, as shown in FIGS. 2 and 3, comprises: a lifter member (moving member) 26 disposed in a vertical direction; a plurality of substrate retainer frames of which one ends are fixed to lower end portion of this lifter member 26 respectively to be disposed in a horizontal direction, that is, a central substrate retainer frame 28 fixed to the central portion of the lower end portion of the lifter member 26 in the illustrated example; and a pair of substrate retainer frames 30, 30 fixed to the left and right of the lower end portion of the lifter member 26; a fixed frame (fixed member) 32 that is integrally fixed to respective other ends of these substrate retainer frames 28 and 30; and retainer members 34a, 34b; 36a, 36b that are secured to each of the substrate retainer frames 28 and 30 respectively, and are in contact with the lower end portions of substrates W to hold the substrates W.

The lifter member 26 is supported so as to be capable of moving upward and downward between an internal part of the treatment reservoir 10 and positions above the treatment reservoir 10 by the support and moving mechanism, not shown. This lifter member 26 is made of Sic material 26a as shown in FIG. 4A. Alternatively, as shown in FIG. 4B, the lifter member 26 has such a cross sectional structure as a CVD SiC film 26c is deposited on the surface of a base member 26b that is made of SiC. The CVD SiC film 26c is formed on the base material 26b, for example, in the process that a base material 26b made of SiC is brought in a heating furnace to be sprayed or coated with raw material under the heated state. At this time, it is desirable that the CVD SiC film 26c is 10 μm to 30 μm in thickness.

Furthermore, each of the substrate retainer frames 28, 30 and the fixed frame 32 has such a cross sectional structure as being made of SiC respectively or that a CVD SiC film is deposited on the surface of a base material that is made of SiC. The CVD SiC film is formed on the base material, for example, in the process that a base material made of SiC is brought in a heating furnace to be sprayed or coated with raw material under the heated state. At this time, it is desirable that the CVD SiC film is 10 μm to 30 μm in thickness.

The retainer members 34a, 34b; 36a, 36b, which are fixed to the substrate retainer frames 28, 30, are formed of elongated thin plates, and are secured to both sides of each of the substrate retainer frames 28 and 30 using fastening devices (bolts and nuts). These retainer members 34a, 3b; 36a, 36b, and fastening devices 38 are made of fluororesin, for example, PTFE, PFE, PVDF, PCTFE, or PEEK having high chemical resistance respectively. A substrates W is supported at the central portion of the lower edge with the retainer members 34a and 34b fixed to the central substrate retainer frame 28, as well as is supported at either side in the vicinity of the lower edge with the retainer members 36a and 36b secured to each of a pair of substrate retainer frames 30 on both sides respectively. Thus, the substrates W are held in the standing posture. Furthermore, the retainer members 34a, 34b; 36a, 36b, as shown in FIG. 3, include a plurality of substrate retainer grooves 40a, 40b; 42a, 42b that engage with the lower edges of the substrates W. Accordingly, plural pieces of substrates W are configured to be in array horizontally with a predetermined pitch at a little spacing from each other to hold.

As described above, since each of the lifter member 26, the substrate retainer frames 28 and 30 as well as and the fixed frame 32 of the substrate holder 12 has such cross sectional structure as being made of SiC or that a CVD SiC film is deposited on the surface of a base material that is made of SiC, even in the case where any high concentration of hydrofluoric acid, phosphoric acid, or sulfuric acid are stored in the treatment reservoir 10 and substrates W are immersed in these treatment solutions to make the treatment of the substrates W, there is no fear that the lifter member 26, the substrate retainer frames 28 and 30, and the fixed frame 32 are corroded in this substrate holder 12.

While the presently preferred embodiment of the invention has been shown and described, it is to be understood that the disclosure is for the purpose of illustration and that various changes and modifications may be made without departing from the scope of the invention as set forth in the appended claims.

1. A substrate holder, which causes plural pieces of substrates to be arrayed in a standing posture to hold, comprising:
a moving member that is capable of moving between an internal part of a treatment reservoir, in which a treatment solution is stored, and positions above said treatment reservoir, and that is made of SiC;
a plurality of substrate retainer frames that are fixed to said moving member, and are located in a horizontal direction along the array direction of the substrates respectively; and
a retainer member that is formed at said substrate retainer frames, and is in contact with the lower end portions of the substrates to hold the substrates.

2. The substrate holder according to claim 1, wherein a CVD SiC film is deposited on the surface of said moving member.

3. The substrate holder according to claim 2, wherein said CVD SiC film that is deposited on the surface of said moving member is 10 μm to 30 μm in thickness.

4. The substrate holder according to claim 1, wherein said substrate retainer frame is made of SiC.

5. The substrate holder according to claim 4, wherein a CVD SiC film is deposited on the surface of said substrate retainer frame.

6. The substrate holder according to claim 5, wherein said CVD SiC film that is deposited on the surface of said substrate retainer frame is 10 μm to 30 μm in thickness.

7. The substrate holder according to claim 1, wherein said retainer member is made of fluororesin.

8. The substrate holder according to claim 7, wherein fluororesin to form said retainer member is any resin selected from the group consisting of polytetrafluoroethylene, perfluoro alkoxyalkane, polyvinylidene fluoride, polychloro-trifluoroethylene, and polyether ether ketone.

9. The substrate holder according to claim 1, wherein said substrate retainer frame and said retainer member are secured together with a fastening device made of fluororesin.

10. The substrate holder according to claim 9, wherein fluororesin to form said fastening device is any resin selected from the group consisting of polytetrafluoroethyene, perfluoro alkoxyalkane, polyvinylidene fluoride, polychloro-trifluoroethylene, and polyether ether ketone.

11. A substrate treatment apparatus that comprises a treatment reservoir in which a treatment solution is stored, and a substrate holder, which causes plural pieces of substrates to be arrayed in a standing posture to hold, and that contains in an internal part of said treatment reservoir plural pieces of substrates held with said substrate holder, and immerses the plural pieces of substrates in treatment solution in said treatment reservoir to carry out the treatment, said substrate holder further comprising:
a moving member that is capable of moving between in an internal part of a treatment reservoir in which a treatment solution is stored, and positions above said treatment reservoir, and that is made of SiC;
a plurality of substrate retainer frames that are fixed to said moving member, and are located in a horizontal direction along the array direction of the substrates respectively; and
a retainer member that is formed at said substrate retainer frames, and is in contact with the lower end portions of the substrates to hold the substrates.

12. The substrate treatment apparatus according to claim 11, wherein a CVD SiC film is deposited on the surface of said moving member.

13. The substrate treatment apparatus according to claim 12, wherein said CVD SiC film that is deposited on the surface of said moving member is 10 μm to 30 μm in thickness.

14. The substrate treatment apparatus according to claim 11, wherein said substrate retainer frame is made of SiC.

15. The substrate treatment apparatus according to claim 14, wherein a CVD SiC film is deposited on the surface of said substrate retainer frame.

16. The substrate treatment apparatus according to claim 15, wherein a CVD SiC film that is deposited on the surface of said substrate retainer frame is 10 μm to 30 μm in thickness.

17. The substrate treatment apparatus according to claim 11, wherein said retainer member is made of fluororesin.

18. The substrate treatment apparatus according to claim 17, wherein fluororesin to form said retainer member is any resin selected from the group consisting of polytetrafluoroethyene, perfluoro alkoxyalkane, polyvinylidene fluoride, polychloro-trifluoroethylene, and polyether ether ketone.

19. The substrate treatment apparatus according to claim 11, wherein said substrate retainer frame and said retainer member are secured together with a fastening device made of fluororesin.

20. The substrate treatment apparatus according to claim 19, wherein fluororesin to form said fastening device in any resin selected from the group consisting of polytetrafluoroethyene, perfluoro alkoxyalkane, polyvinylidene fluoride, polychloro-trifluoroethylene, and polyether ether ketone.
